(19) United States
(12) Patent Application Publication
(10) Pub. No.: US 2026/0127992 A1
(43) Pub. Date: May 7, 2026

(54) ELECTRONIC DEVICE AND CONTROL METHOD FOR CORRECTING IMAGE AND OUTPUTTING IMAGE

(71) Applicant: SAMSUNG ELECTRONICS CO., LTD., Suwon-si (KR)

(72) Inventors: Taegyoung Ahn, Suwon-si (KR); Bongjoe Kim, Suwon-si (KR); Guiwon Seo, Suwon-si (KR)

(73) Assignee: SAMSUNG ELECTRONICS CO., LTD., Suwon-si (KR)

(21) Appl. No.: 19/351,980

(22) Filed: Oct. 7, 2025

Related U.S. Application Data
(63) Continuation of application No. PCT/KR2025/012176, filed on Aug. 12, 2025.

(30) Foreign Application Priority Data
Nov. 7, 2024 (KR) 10-2024-0157132

(51) Int. Cl. G09G 3/20

(52) U.S. Cl. CPC G09G 3/2003; G09G 2300/0452; G09G 2320/0242; G09G 2320/0666; G09G 2320/0686; G09G 2360/16

(57) ABSTRACT

An electronic device includes a system on Chip (SoC) and a display including first pixels, each of the first pixels including a first number of first sub pixels. The SoC receives an input image including second pixels, each of the second pixels including a second number of second sub pixels, obtains, based on the second number of the second sub pixels being greater than the first number of the first sub pixels a sampling image by sampling the input image based on the first sub pixels, obtains a first filtering image by applying a first human visual system (HVS) filtering to the sampling image, obtains a second filtering image by applying a second HVS filtering to the input image, obtains an output image by compensating a color value of the sampling image based on a color difference of the first filtering image and the second filtering image, and displays the output image on the display.

### CROSS-REFERENCE TO RELATED APPLICATION(S)

This application is a bypass continuation of International Application No. PCT/KR2025/012176, filed on Aug. 12, 2025, which is based on and claims priority to Korean Patent Application No. 10-2024-0157132, filed on Nov. 7, 2024, in the Korean Intellectual Property Office, the disclosures of which are incorporated by reference herein in their entireties.

### BACKGROUND

### 1. Field

The disclosure relates to an electronic device and a control method for correcting and outputting an image.

### 2. Description of Related Art

With recent developments in display technology, display devices of various types are being developed to be used in various locations such as homes, offices, and public spaces.

According to one example, a display device may have one pixel including three sub pixels (R, G, B). According to another example, display devices may include pixel structure with less than three sub pixels for various reasons such as a life span, an aperture ratio, power consumption, and the like of a device.

The above-described information may be provided as related art for the purpose of aiding in the understanding of the disclosure. No claim or determination is made in any way with respect to whether any of the above-described description may be applied as prior art associated with the disclosure.

### SUMMARY

According to an aspect of the disclosure, there is provided an electronic device, including a display including first pixels, each of the first pixels including a first number of first sub pixels, and a system on Chip (SoC), wherein the SoC is configured to: receive an input image including second pixels, each of the second pixels including a second number of second sub pixels, obtain, based on the second number of the second sub pixels being greater than the first number of the first sub pixels a sampling image by sampling the input image based on the first sub pixels, obtain a first filtering image by applying a first human visual system (HVS) filtering to the sampling image, obtain a second filtering image by applying a second HVS filtering to the input image, obtain an output image by compensating a color value of the sampling image based on a color difference of the first filtering image and the second filtering image, and display the output image on the display.

The SoC may be further configured to: compensate the sampling image by compensating for the color difference of the second filtering image and the first filtering image corresponding to a first pixel in the first filtering image by performing diffusion to the first pixel and a plurality of surrounding pixels surrounding the first pixel.

The SoC may be further configured to: compensate for a first color difference of the first filtering image and the second filtering image corresponding to a first sub pixel in the first pixel by performing diffusion to the first sub pixel and a plurality of first adjacent sub pixels surrounding the first sub pixel, and compensate for a second color difference of the first filtering image and the second filtering image corresponding to a second sub pixel in the pixel by performing diffusion to the second sub pixel and a plurality of second adjacent sub pixels surrounding the second sub pixel.

The SoC may be further configured to: compensate for the first color difference corresponding to the first sub pixel by performing diffusion to the first sub pixel and the plurality of first adjacent sub pixels based on a first weight value corresponding to the first sub pixel and a second weight value corresponding to the plurality of first adjacent sub pixels, and compensate for the second color difference corresponding to the second sub pixel by performing diffusion to the second sub pixel and the plurality of second adjacent sub pixels based on a third weight value corresponding to the second sub pixel and a fourth weight value corresponding to the plurality of second adjacent sub pixels.

The SoC may be further configured to: identify the first weight value and the second weight value based on pre-set weight values or at least one from among a filter coefficient applied to the first HVS filtering, positions of the first sub pixel and the plurality of first adjacent sub pixels, and the first color difference, and identify the third weight value and the fourth weight value based on the pre-set weight values or at least one from among a filter coefficient applied to the second HVS filtering, positions of the second sub pixel and the plurality of second adjacent sub pixels, and the second color difference.

The SoC may be further configured to: identify a first luminance value corresponding to a first pixel of the first filtering image and a second luminance value corresponding to a second pixel of the second filtering image, the second pixel of the second filtering image corresponding to the first pixel of the first filtering image, identify a color difference of the first filtering image and the second filtering image based on a first color value and the first luminance value of the first pixel of the first filtering image, and a second color value and the second luminance value of the second pixel of the second filtering image, and compensate the sampling image by compensating for the color difference by performing diffusion to the first pixel and the a plurality of pixels surrounding the first pixel.

The SoC may be further configured to: identify a color difference of the first filtering image and the second filtering image based on a first difference value having subtracted the first luminance value from the first color value for each sub pixel in the first pixel of the first filtering image and a second difference value having subtracted the second luminance value from the second color value for each sub pixel in the second pixel of the second filtering image.

The SoC may be further configured to: obtain one red (R) sub pixel value in the sampling image based on a plurality of R sub pixel values in the input image, obtain one green (G) sub pixel value in the sampling image based on a plurality of G sub pixel values in the input image, and obtain one blue (B) sub pixel value in the sampling image based on a plurality of B sub pixel values in the input image.

The SoC may be further configured to: predict a first region in which color fringing occurs in the input image based on pixel information of the input image, and obtain the output image based on the sampling image in which the color value is compensated for the first region and based on the sampling image in which the color value is not compensated for a second region in the input image.

The display may be implemented as a pentile display of an RGBG sub pixel structure in which each pixel includes an R sub pixel and a G sub pixel, or includes a B sub pixel and the G sub pixel.

According to an aspect of the disclosure, there is provided a control method of an electronic device including a display including first pixels, each of the first pixels including a first number of first sub pixels, the method including: receiving an input image including second pixels, each of the second pixels including a second number of second sub pixels, obtaining, based on the second number of the second sub pixels being greater than the first number of the first sub pixels, a sampling image by sampling the input image based on the first sub pixels, obtaining a first filtering image by applying a first human visual system (HVS) filtering to the sampling image, obtaining a second filtering image by applying a second HVS filtering to the input image, obtaining an output image by compensating a color value of the sampling image based on a color difference of the first filtering image and the second filtering image, and displaying the output image on the display.

The obtaining the output image may include: compensating the sampling image by compensating for the color difference of the second filtering image and the first filtering image corresponding to a first pixel in the first filtering image by performing diffusion to the first pixel and a plurality of surrounding pixels surrounding the first pixel.

The compensating the sampling image may include: compensating for a first color difference of the first filtering image and the second filtering image corresponding to a first sub pixel in the first pixel by performing diffusion to the first sub pixel and a plurality of first adjacent sub pixels surrounding the first sub pixel, and compensating for a second color difference of the first filtering image and the second filtering image corresponding to a second sub pixel in the pixel by performing diffusion to the second sub pixel and a plurality of second adjacent sub pixels surrounding the second sub pixel.

The compensating the sampling image may include: compensating for the first color difference corresponding to the first sub pixel by performing diffusion to the first sub pixel and the plurality of first adjacent sub pixels based on a first weight value corresponding to the first sub pixel and a second weight value corresponding to the plurality of first adjacent sub pixels, and compensating for the second color difference corresponding to the second sub pixel by performing diffusion to the second sub pixel and the plurality of second adjacent sub pixels based on a third weight value corresponding to the second sub pixel and a fourth weight value corresponding to the plurality of second adjacent sub pixels.

According to an aspect of the disclosure, there is provided a non-transitory computer-readable medium that stores instructions for an electronic device to perform an operation when executed by a System on Chip (SoC) of the electronic device that includes a display including first pixels, each of the first pixels including a first number of first sub pixels, wherein the operation includes: receiving an input image including second pixels, each of the second pixels including a second number of second sub pixels, obtaining, based on the second number of the second sub pixels being greater than the first number of the first sub pixels, a sampling image by sampling the input image based on the first sub pixels, obtaining a first filtering image by applying a first human visual system (HVS) filtering to the sampling image, obtaining a second filtering image by applying a second HVS filtering to the input image, obtaining an output image by compensating a color value of the sampling image based on a color difference of the first filtering image and the second filtering image, and displaying the output image on the display.

### BRIEF DESCRIPTION OF DRAWINGS

Aspects above and other aspects and features of specific embodiments of the disclosure will be made clearer from the following description taken in together with the accompanying drawings.

FIG. 1A to FIG. 1D are diagrams illustrating various pixel structures to aid in the understanding of the disclosure;

FIG. 2A is a diagram illustrating an example case in which an RGB image is displayed on a display of an RGB sub pixel structure;

FIG. 2B is a diagram illustrating an example case in which an RGB image is displayed on a display of an RGBG sub pixel structure according to an embodiment;

FIG. 3A is a block diagram illustrating a configuration of an electronic device according to an embodiment;

FIG. 3B is a diagram illustrating one implementation example of an electronic device according to an embodiment;

FIG. 4 is a flowchart illustrating a control method of an electronic device according to an embodiment;

FIG. 5A and FIG. 5B are diagrams illustrating a sampling image obtaining method (operation 420) according to an embodiment;

FIG. 6 is a diagram illustrating one example of an output image obtaining method according to an embodiment;

FIG. 7A and FIG. 7B are diagrams illustrating an example of a human visual system (HVS) filter according to an embodiment;

FIG. 8 is a flowchart illustrating a control method of an electronic device according to an embodiment; and

FIG. 9 is a diagram illustrating an output image obtaining method according to an embodiment.

### DETAILED DESCRIPTION

The disclosure will be described in detail below with reference to the accompanying drawings.

Terms used in the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation (analyzing a phone call, a message, a schedule, etc.) but based on the meaning of the term and the overall context of the disclosure.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

The expression at least one of A and/or B is to be understood as indicating any one of “A” or “B” or “A and B”.

Expressions such as “1st”, “2nd”, “first”, or “second” used in the disclosure may limit various elements regardless of order and/or importance, and may be used merely to distinguish one element from another element and not limit the elements.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

A singular expression includes a plural expression, unless otherwise specified. It is to be understood that the terms such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used herein perform at least one function or operation, and may be implemented with hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor.

In the disclosure, the term “user” may refer to a person using an electronic device or a device (e.g., an artificial intelligence electronic device) using the electronic device.

The various elements and regions of the drawings have been schematically illustrated. Accordingly, the technical spirit of the disclosure is not limited by relative sizes and distances illustrated in the accompanied drawings.

Embodiments of the disclosure will be described in greater detail below with reference to the accompanied drawings.

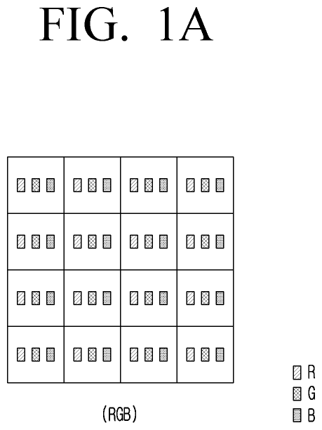

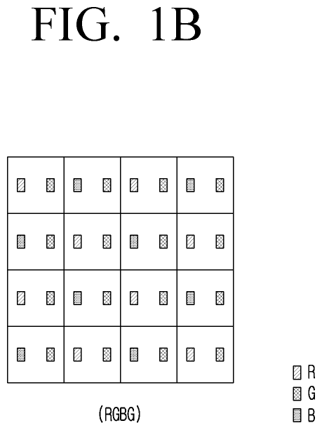

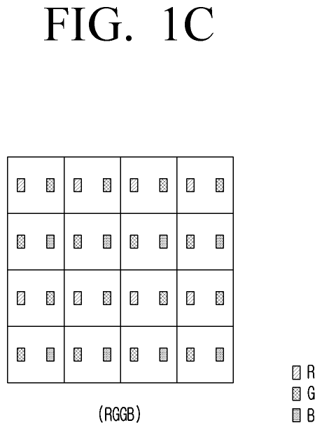

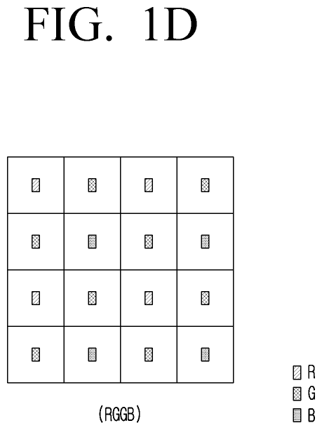

FIG. 1A to FIG. 1D are diagrams illustrating various pixel structures to aid in the understanding of the disclosure.

FIG. 1A is a diagram illustrating an RGB sub pixel structure in which one pixel is formed of three sub pixels according to an example. According to an example, a display may have the RGB sub pixel structure in which one pixel includes three sub pixels (R, G, B) as shown in FIG. 1A. For example, each of the sub pixels (R, G, B) may be arranged horizontally alongside one another.

FIG. 1B is a diagram illustrating an RGBG sub pixel structure in which one pixel is formed of two sub pixels according to an example. According to an example, a display may have the RGBG sub pixel structure in which one pixel includes two sub pixels R and G or B and G as shown in FIG. 1B. For example, a pixel (R, G) and a pixel (B, G) may be provided alternately (or in a crossing manner).

FIG. 1C is a diagram illustrating an RGGB sub pixel structure in which one pixel is formed of two sub pixels. According to an example, a display may have the RGBG sub pixel structure in which one pixel includes two sub pixels ((R, G) or (G, B)) as shown in FIG. 1C. For example, a pixel (R, G) and a pixel (G, B) may be provided alternatively on a column basis. According to an embodiment, a single pixel may include two G sub pixels in order to provide a higher resolution and color reproducibility according to visual characteristics of humans that are more sensitive to green colors.

FIG. 1D is a diagram illustrating an RGBG sub pixel structure in which one pixel is formed of one sub pixel according to an embodiment. According to an example, a display may have the RGBG sub pixel structure in which one pixel is formed of one sub pixel (R or G or B) as shown in FIG. 1D. For example, the R pixel and the G pixel may be arranged alternately in one line, and the G pixel and the B pixel may be arranged alternately in a different line.

According to an embodiment, an input image may be an RGB image formed of color information of three R, G, B sub pixels for every pixel, but as shown in FIG. 1B to FIG. 1D, there may be instances where the image is displayed in a sub pixel structure of less than three. For example, in some displays (e.g., an LED display, a micro LED display, an OLED display), the sub pixel structure of a number less than three may be used as shown in FIG. 1B to FIG. 1D for various reasons such as a lifespan, an aperture ratio, and power consumption of a pixel device. According to an example, a pentile display may have the sub pixel structure of a number less than three as shown in FIG. 1B to FIG. 1D

For convenience of description below, the display will be described as being implemented as the pentile display of the RGBG sub pixel structure in which one pixel is formed of two sub pixels as shown in FIG. 1B.

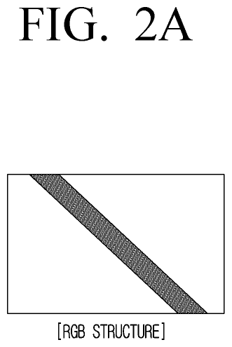

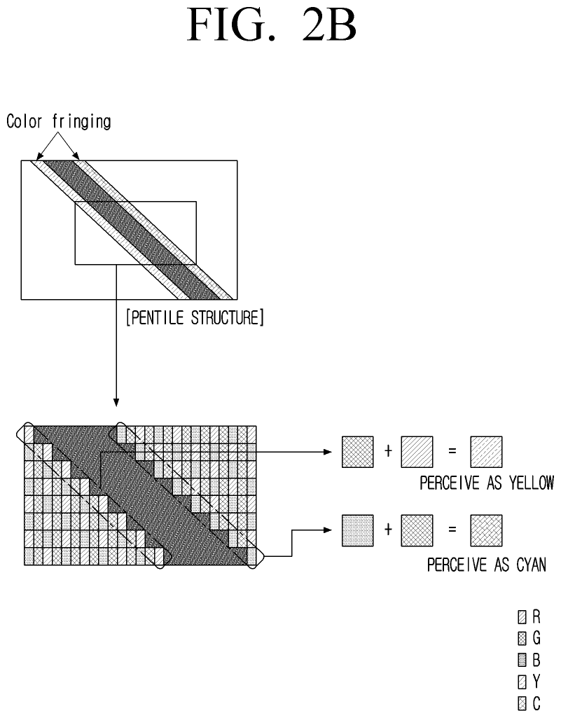

FIG. 2A is a diagram illustrating an example case in which an RGB image is displayed on a display of an RGB sub pixel structure according to an example.

Referring to FIG. 2A, in an example case in which an RGB image is displayed on a display of the RGB sub pixel structure as shown in FIG. 1A, an edge of the RGB image may be clearly depicted and/or understood by a user without color fringing because the sub pixel structure is the same as the RGB image. For example, the sub pixel structure is an RGB structure and the image is an RBG image.

FIG. 2B is a diagram illustrating an example in a case in which an RGB image is displayed on a display of an RGBG sub pixel structure according to an example.

Referring to FIG. 2B, in an example case in which the RGB image is displayed on the pentile display of the RGBG sub pixel structure as shown in FIG. 1B, color fringing due to a lack of sub pixels may occur in an edge region. For example, as shown in FIG. 2B, color fringing may occur in a case in which the edge region is located where an R sub pixel is positioned and/or where a B sub pixel is positioned. For example, in a case in which the edge region is located where the R sub pixel is positioned, the relevant edge may be perceived as yellow to the user, and in a case in which the edge region is located where the B sub pixel is positioned, the relevant edge may be perceived as cyan to the user.

Accordingly, various embodiments of transforming the input image. such that cognitive color fringing does not occur in case the input image and the subpixel structure of the display are different. will be described below.

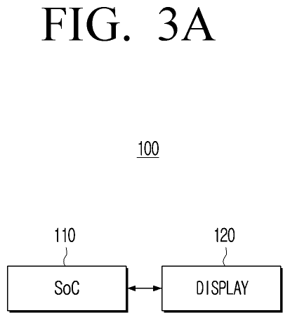

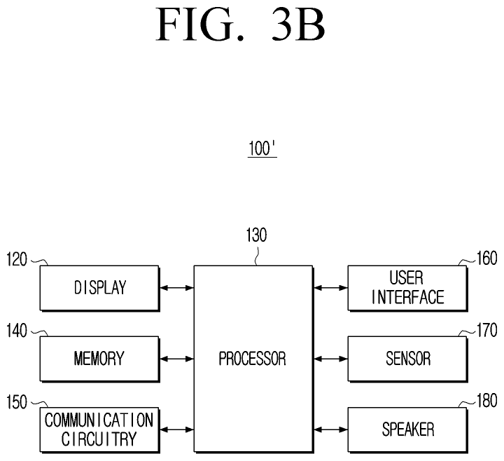

FIG. 3A is a block diagram illustrating a configuration of an electronic device according to an embodiment.

Referring to FIG. 3A, an electronic device 100 may include a System on Chip (SoC) 110 and a display 120.

According to an embodiment, SoC of the electronic device 100 may be a single integrated circuit which integrated various functions in one chip. According to an example, the SoC may be designed as a customized chip for transforming an input image.

According to an embodiment, the display 120 of the electronic device 100 may output visualized information to the user. For example, the display 120 may output visualized information to the user by being controlled by a controller. For example, the controller may include, but is not limited to, a processor or a graphic processing unit (GPU). The display 120 may include, but is not limited to, light emitting diodes (LED), micro LED, mini LED, an organic light emitting diode (OLED) display, a liquid crystal display (LCD) display, a plasma display panel (PDP), a quantum dot (QD) display and/or quantum dot light-emitting diodes (QLED). According to an example, the display 120 may be implemented as a flat display, a curved display, and a flexible display capable of folding and/or rolling.

According to an embodiment, the electronic device 100 may be implemented as at least one from among a home appliance or a user terminal that includes the display 120. According to an example, the electronic device 100 may be implemented as a television (TV), but is not limited thereto, and may be implemented as display devices of various types such as a monitor, a kiosk, a tablet personal computer (PC), an electronic frame, a mobile phone, a large format display (LFD), a digital signage, a digital information display (DID), and a video wall. However, in certain cases, the above may be implemented as an image processing device (e.g., a set-top box, a one connected box) which provides an image connected with a display device.

FIG. 3B is a diagram illustrating one implementation example of an electronic device according to an embodiment.

Referring to FIG. 3B, an electronic device 100′ may include at least one from among the display 120, at least one processor 130, a memory 140, communication circuitry 150, a user interface 160, a sensor 170, or a speaker 180.

For example, at least one from among the display 120, the at least one processor 130, the memory 140, the communication circuitry 150, the user interface 160, the sensor 170, or the speaker 180 may be electronically and/or operably coupled with each other by an electronic component such as a communication bus.

In an embodiment, the hardware of the electronic device 100′ being operably coupled may mean direct connection or indirect connection between the hardware being established via wired or wireless means for a second hardware to be controlled by a first hardware from among the hardware. Although the drawing is shown based on different blocks, the embodiment is not limited thereto, and a portion from among the hardware in FIG. 3B (e.g., at least a portion of the processor 130 and the memory 140) may be included in the SoC 110. Types and/or number of hardware included in the electronic device 100′ may not be limited by that shown in FIG. 3B. For example, the electronic device 100′ may include only a portion from among the hardware components shown in FIG. 3B.

According to an embodiment, the processor 130 of the electronic device 100′ may include hardware for processing data based on one or more instructions. The hardware for processing data may include, for example, an arithmetic and logic unit (ALU), a floating point unit (FPU), a field programmable gate array (FPGA), a central processing unit (CPU), a graphic processing unit (GPU), a neural processing unit (NPU) and/or an application processor (AP). The number of processors 130 may be one or more. For example, the processor 130 may have a structure of a multi-core processor such as a dual core, a quad core, or a hexa core.

The processor 130 may control operations of the electronic device 100′ by executing instructions stored in the memory 140. For example, the processor 130 may correspond to a plurality of processors that divide and collectively perform a plurality of operations between the processors.

According to an embodiment, the memory 140 of the electronic device 100 may include a hardware component for storing data and/or instructions input in and/or output from the processor 130. The memory 140 may be implemented in a form of a memory embedded in the electronic device 100′ according to data storage use, or implemented in a form of a memory attachable to or detachable from the electronic device 100. For example, data for driving the electronic device 100 may be stored in the memory embedded in the electronic device 100′, and data for an expansion function of the electronic device 100 may be stored in the memory attachable to or detachable from the electronic device 100′. Meanwhile, the memory embedded in the electronic device 100′ may be implemented as at least one of a volatile memory (e.g., a dynamic random access memory (DRAM), a static RAM (SRAM), or a synchronous dynamic RAM (SDRAM)), or a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard drive, or a solid state drive (SSD)). In addition, in the case of the memory attachable to or detachable from the electronic device 100′, the memory may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., a USB memory) connectable to a USB port, or the like.

According to an embodiment, in the memory 140 of the electronic device 100, one or more instructions (or commands) indicating computations and/or operations for the processor 130 to perform with data may be stored. A set of one or more instructions may be referred to as firmware, an operating system, a process, a routine, a sub-routine, and/or an application. For example, the electronic device 100 and/or the processor 130 may perform various operations when a set of a plurality of instructions distributed in a form of the operating system, firmware, a driver, and/or the application is executed. Herein, the application being installed in the electronic device 100 may mean that the one or more instructions provided in application form are stored in the memory 140 of the electronic device 100, and that the one or more applications are stored in a format (e.g., a file having an extension designated by the operating system of the electronic device 100′) executable by the processor 130 of the electronic device 100.

The at least one processor 130 may control to process input data according to a pre-defined operation rule or an artificial-intelligence (AI) model stored in the memory 140. The pre-defined operation rule or the AI model are characterized by being created through learning (or training). The being created through learning may mean a pre-defined operation rule or an AI model of a desired feature being created by applying a learning algorithm to a plurality of training data. The learning may be carried out in the device itself in which the artificial intelligence according to an embodiment of the disclosure is performed, or carried out through a separate server/system.

The AI model may be configured with a plurality of neural network layers. At least one layer may have at least one weight value, and perform a computation of the layer through a computation result of a previous layer and at least one defined computation. Examples of the neural network may include a Convolutional Neural Network (CNN), a Recurrent Neural Network (RNN), a Deep Neural Network (DNN), a Restricted Boltzmann Machine (RBM), a Deep Belief Network (DBN), a Bidirectional Recurrent Deep Neural Network (BRDNN), a Deep-Q Networks, and a Transformer, and the neural network in the disclosure may not be limited to the above-described examples except for when specified.

The learning algorithm may be a method for training a predetermined target device (e.g., a robot) to make decisions or predictions on its own using the plurality of training data. Examples of the learning algorithm may include supervised learning, unsupervised learning, semi-supervised learning, or reinforcement learning, and the learning algorithm of the disclosure is not limited to the above-described examples except for when specified.

According to an embodiment, the communication circuitry 150 of the electronic device 100′ may include hardware to support transmitting and/or receiving of electric signals between the electronic device 100′ and an external device (e.g., a server). For example, the communication circuitry 150 may perform communication with an external device, an external storage medium (e.g., USB memory), an external server (e.g., WEBHARD), and the like through communication methods such as, for example, and without limitation, Bluetooth, an AP based Wi-Fi (e.g., wireless LAN network), ZigBee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like. According to an embodiment, the communication circuitry 150 may perform communication with another electronic device, an external server and/or a remote control device, or the like.

According to an embodiment, the user interface 160 of the electronic device 100′ may be implemented as a device such as a button, a touch pad, a mouse, and a keyboard, or implemented as a touch screen or the like capable of performing the above-described display function together with an operation input function.

According to an embodiment, the sensor 170 of the electronic device 100′ may sense various information. The sensor 170 may be implemented as sensors of various types. For example, the sensor 170 may include at least one sensor from among a time of flight (ToF) sensor, an ultrasonic sensor, a radio detection and ranging (RADAR) sensor, a photodiode sensor, a proximity sensor, a passive infrared (PIR) sensor, a pin hole sensor, a pin hole camera, an infrared body detecting sensor, a complementary metal oxide semiconductor (CMOS) image sensor, a heat detection sensor, an optical sensor, and a motion detection sensor.

The sensor 170 may include a touch sensor. The touch sensor may include, but is not limited to a sensor having a form such as a touch film, a touch sheet, and a touch pad and detects a touch operation.

The sensor 170 may include, but is not limited to, at least one from among a camera, a microphone, a CO2 sensor, and an air pressure sensor. The camera may transform a captured image into an electric signal and generate image data based on the transformed signal. For example, the camera may include at least one from among a typical (or basic) camera, a depth camera, and an ultra-wide angle camera. The microphone may be a configuration for receiving input of a user voice or other sounds and transforming to audio data. The CO2 sensor may be a sensor for measuring concentrations of carbon dioxide. The air pressure sensor may be a sensor for sensing surrounding pressure.

The sensor 170 may further include at least one sensor capable of sensing surrounding light, surrounding temperature, and incident direction of light. In this case, the sensor 170 may be implemented as a light sensor, a temperature detection sensor, a light amount sensing layer, or a camera.

The sensor 170 may further include at least one from among an acceleration sensor (or a gravity sensor), a geomagnetic sensor, or a gyro sensor. For example, the acceleration sensor may be a three-axis acceleration sensor. The three-axis acceleration sensor may measure gravity acceleration for each axis, and provide raw data to the processor 130. The geomagnetic sensor or gyro sensor may be used in obtaining orientation information. Here, the orientation information may include at least one from among roll information, pitch information, or yaw information.

According to an embodiment, the speaker 180 of the electronic device 100′ may be configured to output not only various audio data, but also various notification sounds, voice messages, or the like. The processor 130 may control the speaker 180 to output feedback or various notifications in audio form according to various embodiments of the disclosure.

In addition thereto, the electronic device 100′ may further include the camera, the microphone, and the like according to an implementation example.

The camera may be turned-on according to a pre-set event and perform capturing. The camera may transform the captured image into an electric signal and generate image data based on the transformed signal. For example, a subject may be transformed to an electric image signal through a semiconductor optical device (a charge coupled device (CCD)), and the transformed image signal as described above may be signal processed after being amplified and transformed to a digital signal. For example, the camera may include at least one from among a general (or basic) camera and an ultra-wide angle camera.

The microphone may be a configuration for receiving input of the user voice or other sounds and transforming to audio data. However, according to another embodiment, the electronic apparatus 100′ may receive the user voice input through an external device through the communication circuitry 150.

Meanwhile, according to an implementation example of the electronic device 100′, the speaker, a tuner, and a demodulator may be additionally included. The tuner may receive radio frequency (RF) broadcast signals by tuning a channel selected by the user or all pre-stored channels from among the RF broadcast signals received through an antenna. The demodulator may receive and demodulate digital intermediate frequency (DIF) signals transformed in the tuner, and perform channel decoding, and the like. According to an embodiment, the input image received through the tuner may be processed through the demodulator and then provided to the processor 130.

According to an embodiment, the processor 130 may image process an input image in an example case in which the input image is received. According to an example, the image processing may be a digital image processing which includes at least one from among image enhancement, image restoration, image transformation, image analysis, image understanding, image compression, image decoding, or scaling. Although the above-described image processing may be performed for the input image before or after processing according to various embodiments which will be described below, the part with respect to image processing will be omitted for convenience of description. In the disclosure, the term “region” may mean at least one pixel block or a set of pixel blocks as a term that refers to one portion of an image. In addition, the “pixel block” may mean a set of adjacent pixels including at least one pixel.

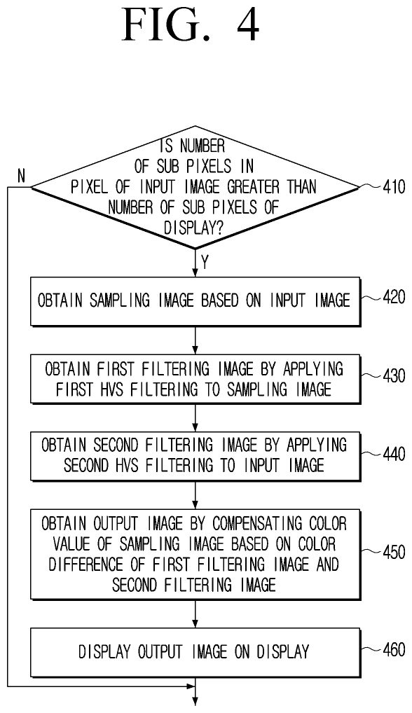

FIG. 4 is a flowchart illustrating a control method of an electronic device according to an embodiment.

In the embodiments below, each of the operations may be performed sequentially, but the operations may not be necessarily performed in sequential order. For example, the order of each of the operations may be changed, and at least two operations may be performed in parallel.

According to an embodiment, operation 410 to operation 470 may be understood as being performed in the SoC 110 of the electronic device 100. However, the disclosure is not limited thereto, and as such, operation 410 to operation 470 may be implemented by another component or another device.

Referring to FIG. 4, in operation 410, the method may include identifying whether a pixel of an input image includes more sub pixels than a number of sub pixels in a pixel of the display 120. For example, the electronic device 100 may identify whether a pixel of an input image includes more sub pixels than a number of sub pixels in a pixel of the display 120. For example, the electronic device 100 may identify whether a number of sub pixels in each of a plurality of pixels in the input image is greater than a number of sub pixels in each of a plurality of pixels of the display 120.

According to an example, the input image may be an RGB image, and the display 120 may be implemented as the pentile display of the RGBG sub pixel structure as shown in FIG. 1B. In this case, because a number of sub pixels of a pixel in the input image is three, and a number of sub pixels of a pixel in the display 120 is two, the number of sub pixels of the pixel in the input image may be identified as greater than the number of sub pixels of the pixel in the display 120.

In operation 420, the method may include obtaining a sampling image based on the input image. For example, based on the pixel of the input image being identified as including more sub pixels than the number of sub pixels in the pixel of the display 120 (410: Y), the electronic device 100 may obtain a sampling image based on the input image.

The sampling image may be an image sampling color information of each sub pixel of the RGB image so as to correspond to the sub pixels of the display 120. For example, sampling may be a process for appropriately outputting pentile sampling image data from a pentile structure display 120 having the RGBG sub pixel structure. Herein, a process for transforming an RGB image to an image outputtable on the pentile structure display 120 having the RGBG sub pixel structure may be referred to as pentile sampling (or RGBG sampling), and an image obtained through the relevant process may be referred to as a pentile sampling image (or RGBG sampling image or RGBG image).

According to an embodiment, the electronic device 100 may identify R, G, B sub pixel values included in each pixel by analyzing the RGB image, and rearrange the R, G, B sub pixel values so as to correspond to a sub pixel pattern of the pentile structure. For example, with a RGBG sub pixel pattern, a number of the R sub pixels and the B sub pixels may be reduced, and a number of G sub pixels may be increased. Accordingly, one of each of the R sub pixel and the B sub pixel may be left in a 2×2 block in a transformation process, and the remaining may be filled with G sub pixels. However, as described above, in an example case in which an RGBG image is transformed to the pentile structure, because a position of a sub pixel is changed, an interpolation processing may be necessary to maintain visual quality of the image. The interpolation may be process of calculating values of sub pixels that are lacking with surrounding values and filling the same. In this process, an algorithm (e.g., sub-pixel rendering) complementing the color values of each pixel may be used in adjacent pixels. However, various methods for obtaining the pentile sampling image from the RGB image may be used.

In operation 430, the method may include obtaining a first filtering image by applying a first filtering to the sampling image. For example, the electronic device 100 may obtain the first filtering image by applying a first human visual system (HVS) filtering to the sampling image (e.g., a pentile sampling image). For example, the electronic device 100 may obtain the first filtering image by applying the first HVS filtering to the RGB image.

The HVS filtering may be a method for emphasizing an important part in an image (e.g., a part better understood by a person), or reducing or removing a less important part in an image when processing an image or a video utilizing the sensitivity of the human visual system. According to an example, the HVS filtering may perform filtering by applying higher weight values to specific components, and applying low weight values to less important components based on the sensitivity of the HVS. According to an example, a Gaussian filter may be used for the HVS filtering. The Gaussian filter may use blurring as a method for reducing high-frequency components and emphasizing low-frequency components in an image. However, the Gaussian filter may not necessarily be used for the HVS filtering, and filters of various types that provide the same/similar filtering effect as the Gaussian filter may be used. The filter used in HVS filtering may be referred to as an HVS filter for convenience of description below.

According to an example, in an example case in which a first HVS filtering is applied to the pentile sampling image, a cognition prediction image showing how the pentile sampling image is actually recognized by the user may be obtained.

In operation 440, the method may include obtaining a second filtering image by applying a second HVS filtering to the input image. For example, the electronic device 100 may obtain the second filtering image by applying the second HVS filtering to the input image. For example, the electronic device 100 may obtain the second filtering image by applying the second HVS filtering to the pentile sampling image (or a pentile sub pixel structure image).

According to an example, in an example case in which the second HVS filtering is applied to the RGB image, a cognition prediction image showing how the RGB image is actually recognized by the user may be obtained.

In operation 450, the method may include obtaining an output image by compensating the color values of the sampling image based on a color difference of the first filtering image and the second filtering image. For example, the electronic device 100 may obtain an output image by compensating the color values of the sampling image based on a color difference (or color error) of the first filtering image and the second filtering image. For example, the electronic device 100 may obtain the output image by compensating the color values of the sampling image based on the color difference actually recognized by the user.

According to an example, the electronic device 100 may compensate the sampling image by compensating for a color difference of the first filtering image and the second filtering image corresponding to the pixels included in the first filtering image by performing diffusion to a relevant pixel and a plurality of pixels surrounding the relevant pixel. For example, the electronic device 100 may compensate for a luminance difference from a cognitive aspect that occurs when having sampled (hereinafter, referred to as pentile sampling) the input image as an image of a pentile sub pixel structure by appropriately performing diffusion to the surrounding pixels.

According to an example, the electronic device 100 may compensate the sampling image by compensating for the color difference for each sub pixel included in the relevant pixel by performing diffusion to each sub pixel and a plurality of pixels surrounding each sub pixel. For example, the electronic device 100 may compensate for a first color difference of the first filtering image and the second filtering image which corresponds to a first sub pixel by performing diffusion to the first sub pixel and a plurality of first adjacent sub pixels surrounding the first sub pixel. In addition, the electronic device 100 may compensate for a second color difference of the first filtering image and the second filtering image which corresponds to a second sub pixel by performing diffusion to the second sub pixel and a plurality of second adjacent sub pixels surrounding the second sub pixel. For example, the electronic device 100 may compensate for an R component color difference of the first filtering image and the second filtering image which corresponds to the R sub pixel by performing diffusion to the R sub pixel and a plurality of adjacent R sub pixels. For example, the electronic device 100 may compensate for a G component color difference of the first filtering image and the second filtering image which corresponds to a G sub pixel by performing diffusion to the G sub pixel and a plurality of adjacent G sub pixels. For example, the electronic device 100 may compensate for a B component color difference of the first filtering image and the second filtering image which corresponds to the B sub pixel by performing diffusion to the B sub pixel and a plurality of adjacent B sub pixels.

According to an example, the electronic device 100 may compensate for the first color difference corresponding to the first sub pixel by performing diffusion to the first sub pixel and the plurality of first adjacent sub pixels based on a first weight value corresponding to the first sub pixel and a second weight value corresponding to a plurality of first adjacent sub pixels. According to an example, the first weight value and the second weight value may be same or different. For example, it may be assumed that the first sub pixel is a reference R sub pixel, the first adjacent sub pixels are four adjacent R sub pixels, the first color difference is A, the first weight value is w1, the second weight value is w2, and the same weight value is applied to the adjacent R sub pixels. In this case, a color difference of color difference A*w1 may be compensated to the reference R sub pixel, and a color difference of A*w2 may be compensated to the four adjacent R sub pixels. Here, the sum of the weight values may be (w1+w2*4=1).

According to an example, the first weight value and the second weight value may be identified based on at least one from among a filter coefficient applied to the first HVS filtering, positions of the first sub pixel and the first adjacent sub pixels, and the first color difference or pre-set weight values.

According to an example, the electronic device 100 may compensate for the second color difference corresponding to the second sub pixel by performing diffusion to the second sub pixel and the plurality of second adjacent sub pixels based on a third weight value corresponding to the second sub pixel and a fourth weight value corresponding to a plurality of second adjacent sub pixels. According to an example, the third weight value and the fourth weight value may be same or different. According to an example, the third weight value may be same as the first weight value and the fourth weight value may be same as the second weight value, but the embodiment is not limited thereto. For example, it may be assumed that the second sub pixel is a reference G sub pixel, the second adjacent sub pixels are four adjacent G sub pixels, the second color difference is B, the third weight value is w3, the fourth weight value is w4, and the same weight value is applied to the adjacent G sub pixels. In this case, a color difference of color difference B*w3 may be compensated to the reference G sub pixel, and a color difference of B*w2 may be compensated to the four adjacent G sub pixels. Here, the sum of the weight values may be (w3+w4*4=1).

According to an example, the third weight value and the fourth weight value may be identified based on at least one from among the filter coefficient applied to the second HVS filtering, positions of the second sub pixel and the second adjacent sub pixels, and the second color difference or pre-set weight values.

According to an example, the second weight value and the fourth weight value with respect to the adjacent sub pixels may be changed according to left/right positions of the adjacent sub pixels.

In operation 460, the method may include displaying the output image on the display. For example, the electronic device 100 may display the output image on the display 120. For example, the electronic device 100 may control the display 120 to display the output image. For example, the electronic device 100 may display the color difference compensated first filtering image obtained in operation 450 on the display 120. For example, the color difference compensated first filtering image may be a pentile sub pixel structure image corresponding to the RGBR display structure in which the color difference with the second filtering image has been compensated.

In an example case in which the pixel of the input image is identified as not including more sub pixels than the number of sub pixels in the pixel of the display 120 (410: N), the electronic device 100 may end the process for compensating the image for the RGBR display structure. In this case, the electronic device 100 may control the display 120 to display the input image without processing to compensate the input image for the RGBR display structure.

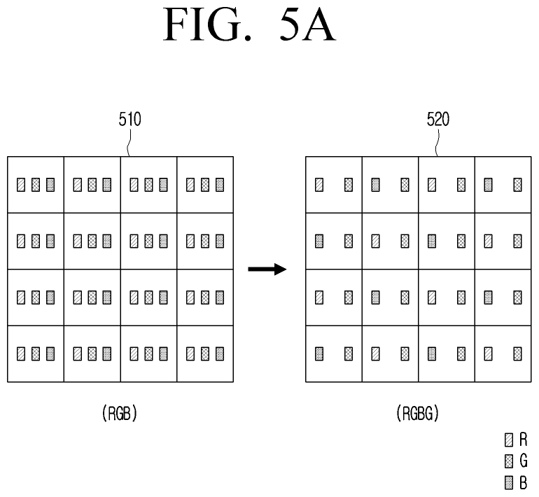

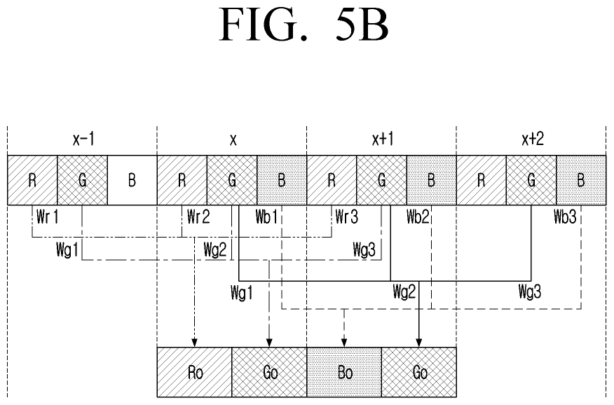

FIG. 5A and FIG. 5B are diagrams illustrating a sampling image obtaining method according to an embodiment.

According to an embodiment, the electronic device 100 may obtain the pentile sampling image by sampling, for example, the input image as shown in FIG. 5A for an RGB image 510 to correspond to a RGBG sub pixel structure 520 of the display 120.

According to an example, the electronic device 100 may obtain one R sub pixel value included in a sampled image based on a plurality of red (R) sub pixel values included in the input image, obtain one G sub pixel value included in the sampled image based on a plurality of green (G) sub pixel values included in the input image, and obtain one B sub pixel value included in the sampled image based on a plurality of blue (B) sub pixel values included in the input image. For example, the electronic device 100 may obtain the pentile sampling image through sub-pixel rendering as shown in FIG. 5B.

According to an embodiment, the sub-pixel rendering may be a rendering technique that does not calculate on a pixel basis when rendering an image, but uses sub pixels independently. According to an example, the electronic device 100 apply weight values to each sub pixel value of the surrounding pixels included in the RGB image in order to obtain a pixel value of a reference sub pixel (Ro(x), Go(x), Bo(x+1), Go(x+1), . . . ) in the pentile sampling image. For example, the electronic device 100 may perform rendering on the pentile sampling image using weight values as in Equation 1 below.

$$Ro ( x ) = Wr 1 * R ( x - 1 ) + Wr 2 * R ( x ) + Wr 3 * R ( x + 1 ) \qquad [ Equation 1 ]$$

$$Go ( x ) = Wg 1 * G ( x - 1 ) + Wg 2 * G ( x ) + Wg 3 * G ( x + 1 )$$

$$Bo ( x ) = W b 1 * B ( x ) + W b 2 * B ( x + 1 ) + W b 3 * B ( x + 2 )$$

$$Go ( x ) = Wg 1 * G ( x ) + Wg 2 * G ( x + 1 ) + Wg 3 * G ( x + 2 )$$

Here, Ro, Bo, and Go may indicate the sub pixel values of the pentile structure which is a result of sub-pixel rendering, x may indicate a pixel position, and Wr, Wg, and Wb may indicate the weight values (or filter coefficient) for each of the R, G, and B sub pixels. For example, the sum of weight values for each color may be 1.

According to an example, the sub pixels used in sampling (or filtering) may include sub pixels positioned directly at both sides (x−1, x+1) of a reference position (x). However, the embodiment is not limited thereto, and sub pixels at positions (x−2, x+2) spaced apart by two spaces or at positions spaced apart by more than two spaces than the reference position (x) may be used in the filtering. According to an example, a number of sub pixels used in sampling may be three as shown in FIG. 5B, but sub pixels of a number that is more than or less than the above may be used.

According to an example, an image processing effect may vary based on the weight values for sub-pixel rendering. For example, the image processing effect may vary according to how the weight values for sub-pixel rendering are set. For example, the smaller the difference between the weight values of a center position are with weight values of a surrounding position, a color fringing reducing effect may increase, while a side-effect of the image blurring may become more prominent. Likewise, the wider the surrounding position is set for sampling, the color fringing reducing effect may increase, while the side-effect of the image blurring may also become more prominent. Accordingly, the electronic device 100 may set the weight values taking into consideration characteristics for each of the regions of the input image.

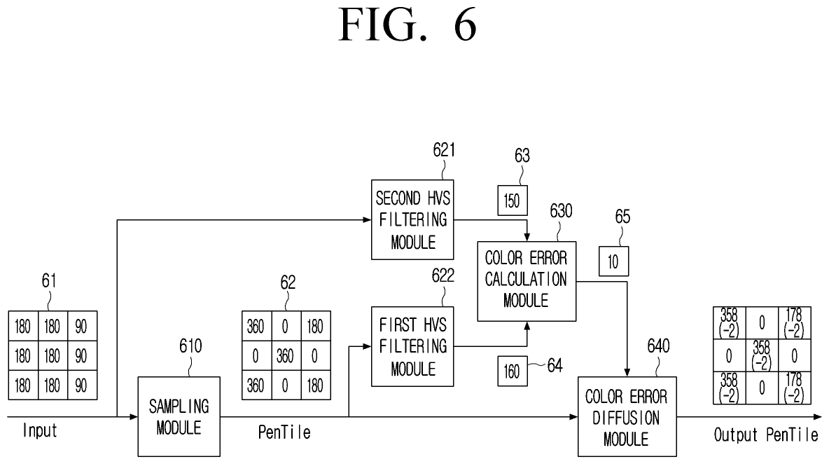

FIG. 6 is a diagram illustrating one example of an output image obtaining method according to an embodiment.

According to an embodiment, at least one from among a pentile sampling module 610, a first HVS filtering module 621, a second HVS filtering module 622, a color error calculation module 630, and a color error diffusion module 640 shown in FIG. 6 may be implemented with at least one software, at least one hardware, and/or a combination thereof. For example, the pentile sampling module 610, the first HVS filtering module 621, the second HVS filtering module 622, the color error calculation module 630, and the color error diffusion module 640 may be implemented to use a pre-defined algorithm, a pre-defined formula, and/or an artificial intelligence model. The pentile sampling module 610, the first HVS filtering module 621, the second HVS filtering module 622, the color error calculation module 630, and the color error diffusion module 640 may be included in the electronic device 100, but may be distributed in at least one external device according to an example.

According to an embodiment, the input image may be an RGB image, and image processing may be performed on each of the R, G, and B sub pixel units included in the RGB image. However, in FIG. 6, an image 61 including a specific sub pixel, for example, a value of the R sub pixel (hereinbelow, referred to as ‘R input image’) as shown in FIG. 6 may be assumed for convenience of description. For example, it may be assumed that the R component in an input 3×3 pixel included in the R input image 61 includes 180, 180, 90 for all three lines.

According to an embodiment, the pentile sampling module 610 may transform the R input image 61 to an R pentile image 62 of the pentile structure through pentile sampling. For example, 0 in the R pentile image 62 may mean that the relevant sub pixel is not present in the display. In an example case in which the R input image 61 goes through pentile sampling, the R sub pixel value of the pentile structure in the R pentile image 62 may become two folds from 180 to 360. This is because luminance of the individual R sub pixels has to be two folds in order for the display to maintain the same luminance because the number of R sub pixels in the pentile structure is only half of that compared to the RGB structure. However, this is merely one example, and the pentile sampling module 610 may obtain the pentile image 62 through sub-pixel rendering which was described in FIG. 5.

According to an embodiment, the first HVS filtering module 622 may obtain a first filtering image 64 by performing HVS filtering on the R pentile image 62. For example, assuming that the HVS filter is a 3×3 mean filter, the 3×3 pixel R pentile image 62 may become a one (1) pixel image having 160 through HVS filtering.

According to an embodiment, the second HVS filtering module 621 may obtain a second filtering image 63 by performing HVS filtering on the R input image 61. According to an embodiment, the second HVS filtering module 621 may obtain a second filtering image 63 by performing HVS filtering on the R input image 61. In an example case in which the HVS filter is assumed as the 3×3 mean filter that obtains a mean value of a 3×3 region, the 3×3 pixel R input image 61 may become the one (1) pixel image having 150 through HVS filtering.

According to an example, because the HVS filtering is reflecting cognitive characteristics by averaging the luminance surrounding eyes of a human, the 3×3 pixel R input image 61 may be recognized as a luminance of 150, and a 3×3 pixel R pentile image 62 may be recognized as a luminance of 160 to the eyes of a human.

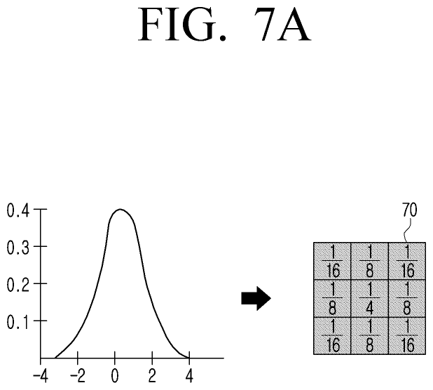

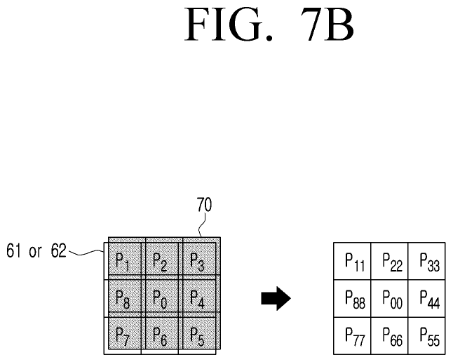

However, in FIG. 6, although the HVS filter has been assumed as the 3×3 mean filter for convenience of description, the Gaussian filter may be used in HVS filtering because the actual eyes of a human is close to the Gaussian filter. For example, the Gaussian distribution may be in a form in which the weight value is high for 0 of an x-axis, and the weight values become smaller as it moves to +/−portion as shown in FIG. 7A, and in an example case in which a Gaussian distribution as described above is applied to a mask 70 in 3*3 form, the weight values may be high for a center of the mask 70, and the weight values may become smaller as to moves to the edge of the mask 70. However, the values shown in FIG. 7A are merely examples, and filtering values may vary according to a sigma value of a Gaussian function. According to an example, the electronic device 100 may apply a Gaussian mask 70 to each of the 3×3 pixel R input image 61 and the 3×3 pixel R pentile image 62 as shown in FIG. 7B. According to an example, because characteristics change according to various factors such as a viewing distance, an appropriate filter size and/or coefficient suitable to the object may be used in HVS filtering.

According to an embodiment, the color error calculation module 630 may calculate color errors based on the first filtering image 64 and the second filtering image 63. For example, the color error calculation module 630 may calculate a color error 10 based on “color value of the first filtering image 64—color value of the second filtering image 63”. The above may mean that, in the embodiment shown in FIG. 6, the luminance of the R input image appears to have increased by 10 to the eyes of a user going through pentile sampling. However, in the relevant example, because only the R component is assumed as handled, it may mean that the red color appears darker by 10 to the eyes of the user.

According to an embodiment, the color error diffusion module 640 may obtain the output image by compensating for the R pentile image 62 by performing diffusion based on the calculated color error. For example, the color error diffusion module 640 may diffuse, in order to compensate the luminance difference from a cognitive aspect generated before and after pentile sampling, the difference appropriately to the surrounding pixels. For example, referring to FIG. 6, because there are five positions at which the sub pixels in the 3×3 in the R pentile image 62, the color error diffusion module 640 may divide the luminance difference 10 into five equal parts and subtract by two each from each sub pixel. However, in the relevant example, because of assuming that only the R component is handled, the color error diffusion module 640 may subtract from the pixel value of the R sub pixel by two each.

According to an embodiment, a method for diffusing the luminance difference may include at least one method from among performing diffusion uniformly to the surrounding pixels, performing diffusion by applying weight values according to a HVS filter coefficient, allocating high weigh values to a center position than the surrounding positions, allocating high weight values to the surrounding positions than the center position, applying weight values to only the center position or the surrounding position, and applying a higher weight value to a position with a small color error from among the surrounding positions.

In the above-described embodiment, although only the R sub pixel has been described for convenience of description, but the same method may be applied for the G sub pixel and the B sub pixel.

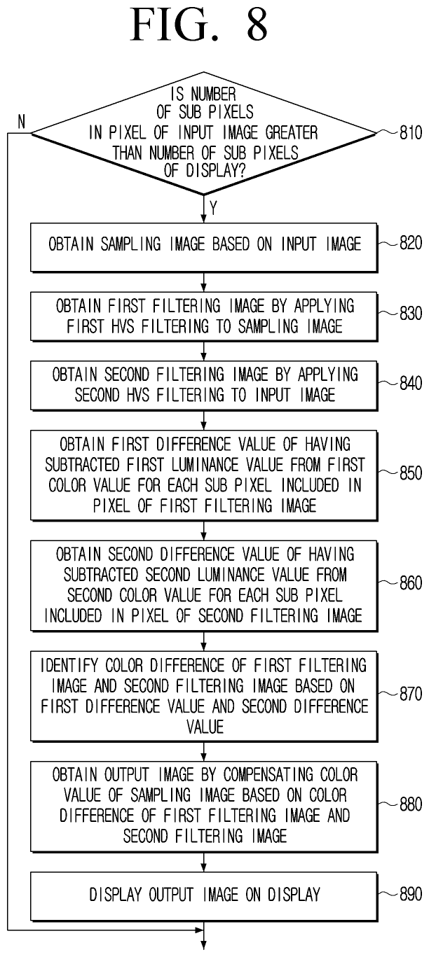

FIG. 8 is a flowchart illustrating a control method of an electronic device according to an embodiment.

In the embodiments below, each of the operations may be performed sequentially, but the operations may not be necessarily performed in sequential order. For example, the order of each of the operations may be changed, and at least two operations may be performed in parallel.

According to an embodiment, operation 810 to operation 890 may be understood has being performed in the SoC 110 of the electronic device 100. Detailed descriptions of operations that overlap with operation 410 to operation 470 shown in FIG. 4 from among operation 810 to operation 890 will be omitted.

According to an embodiment, a luminance component may be included in the color difference (or color error) according to the method described in FIG. 4. According to an example, the electronic device 100 may calculate only a pure color difference excluding the luminance component from the color difference. According to an example, the electronic device 100 may identify a first luminance value corresponding to a pixel of the first filtering image and a second luminance value corresponding to the pixel of the second filtering image, and identify the color difference of the first filtering image and the second filtering image based on a first color value and a first luminance value of the pixel of the first filtering image, and a second color value and the second luminance value of the pixel of the second filtering image. In FIG. 8, the relevant embodiment will be described in detail.

Referring to FIG. 8, in operation 810, the electronic device 100 may identify whether a pixel of the input image includes more sub pixels than the number of sub pixels of the display 120.

In an example case in which the pixel of the input image is identified as including more sub pixels than the number of sub pixels of the display 120 (810: Y), in operation 820, the electronic device 100 may obtain a sampling image based on the input image. For example, the electronic device 100 may obtain the pentile sampling image.

In operation 830, the electronic device 100 may obtain the first filtering image by applying the first HVS filtering to the sampling image (e.g., pentile sampling image).

In operation 840, the electronic device 100 may obtain the second filtering image by applying the second HVS filtering to the input image.

In operation 850, the method may include obtaining a first difference value based on the first luminance value and the first color value for each sub pixel included in the pixel of the first filtering image. For example, the electronic device 100 may obtain a first difference value having subtracted the first luminance value (or a first brightness value) from the first color value for each sub pixel included in the pixel of the first filtering image. For example, the first luminance value may be a luminance value corresponding to the pixel of the first filtering image. For example, the electronic device 100 may obtain a luminance value corresponding to a pixel according to a pre-set luminance calculation formula. For example, the electronic device 100 may calculate a luminance value of Y according to an RGB_to_Y( ) function such as Y=0.2126×R+0.7152×G+0.0722×B. As described above, different weight values being applied to R, G, and B is because of the sensitivity recognized by the eyes of a human being different for each color component. However, the embodiment is not limited thereto, and the luminance value may be calculated by applying the same weight values to R, G, and B.

In operation 860, the method may include obtaining a second difference value based on the second luminance value and the second color value for each sub pixel included in the pixel of the second filtering image. For example, the electronic device 100 may obtain a second difference value having subtracted the second luminance value (or a second brightness value) from the second color value for each sub pixel included in the pixel of the second filtering image. For example, the second luminance value may be a luminance value corresponding to the pixel of the second filtering image. The second luminance value may be calculated in the same method as the first luminance value.

According to an example, the electronic device 100 may obtain a first difference value of the first filtering image and a second difference value of the second filtering image based on Equation 2 below.

$$Y 1 = RGB\_to \_Y ( R 1 , G 1 , B 1 ) \qquad [ Equation 2 ]$$

$$R {1}^{′} = R 1 - Y 1$$

$$G {1}^{′} = G 1 - Y 1$$

$$B {1}^{′} = B 1 - Y 1$$

$$Y 2 = RGB\_to \_Y ( R 2 , G 2 , B 2 )$$

$$R {2}^{′} = R 2 - Y 2$$

$$G {2}^{′} = G 2 - Y 2$$

$$B {2}^{′} = B 2 - Y 2$$

Here, Y1 may be a luminance value of the first filtering image, and Y2 may be a luminance value of the second filtering image. R1, G1, and B1 may be sub pixel values of the first filtering image, and R2, G2, and B2 may be sub pixel values of the second filtering image. R1′, G1′, and B1′ may be first difference values of the first filtering image, and R2′, G2′, and B2′ may be second difference values of the second filtering image.

According to an example, the electronic device 100 may identify the first difference values R1′, G1′, and B1′ of the first filtering image as color values of the sub pixels with the luminance component excluded, and identify the second difference values R2′, G2′, and B2′ of the second filtering image as color values of sub pixels with the luminance component excluded.

In operation 870, the method may include identifying the color difference of the first filtering image and the second filtering image based on the first difference value and the second difference value. For example, the electronic device 100 may identify the color difference of the first filtering image and the second filtering image based on the first difference value and the second difference value.

According to an example, the electronic device 100 may obtain the color difference of the first filtering image and the second filtering image based on Equation 3 below.

$$ColorError\_R = R {2}^{′} - R {1}^{′} \qquad [ Equation 3 ]$$

$$ColorError\_G = G {2}^{′} - G {1}^{′}$$

$$ColorError\_B = B {2}^{′} - B {1}^{′}$$

Here, R1′, G1′, and B1′ may be color values of sub pixels with the luminance component excluded in the first filtering image. R2′, G2′, and B2′ may be color values of sub pixels with the luminance component excluded in the second filtering image. ColorError_R, ColorError_G, and ColorError_B may be color differences corresponding to the R, G, and B sub pixels of the first filtering image and the second filtering image.

In operation 880, the method may include obtaining an output image by compensating the color values of the sampling image based on the color difference of the first filtering image and the second filtering image. For example, the electronic device 100 may obtain an output image by compensating the color values of the sampling image based on the color difference of the first filtering image and the second filtering image.

According to an example, the electronic device 100 may compensate the sampling image by compensating for the color difference of the first filtering image and the second filtering image by performing diffusion to a relevant pixel and a plurality of pixels surrounding the relevant pixel. According to an example, the electronic device 100 may compensate the sampling image by compensating for a color difference for each sub pixel included in a relevant pixel by performing diffusion to each sub pixel and a plurality of pixels surrounding each sub pixel. Because the method for compensating for the color difference by performing diffusion is same/similar with the method described in operation 450, a detailed description thereof will be omitted.

In operation 890, the electronic device 100 may display the output image on the display 120.

In an example case in which the pixel of the input image is identified as not including more sub pixels than the number of sub pixels in the pixel of the display 120 (810: N), the electronic device 100 may end the process for compensating the image for the RGBR display structure. In this case, the electronic device 100 may control the display 120 to display the input image without processing to compensate the input image for the RGBR display structure.

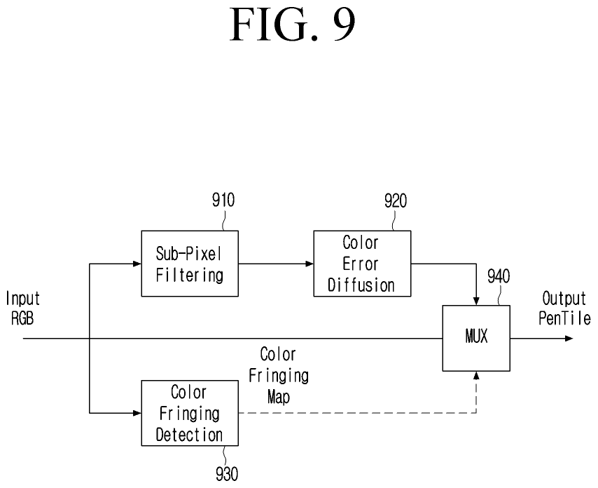

FIG. 9 is a diagram illustrating an output image obtaining method according to an embodiment.

According to an embodiment, in an example case in which the pentile sampling image is obtained through sub-pixel rendering, color fringing may be reduced, but a problem of clarity of the input image being blurred may occur the stronger the color fringing reduction is carried out. Accordingly, according to an embodiment, the electronic device 100 may predict a region in which color fringing occurs in the input image based on pixel information of the input image, and obtain an output image based on the sampling image in which the color value is compensated for the predicted region and based on the sampling image in which the color value is not compensated for the remaining region.

Referring to FIG. 9, the electronic device 100 may obtain a color fringing map including pixel information of a relevant region by predicting the region that includes pixels with which color fringing occurs (930) based on the input image. For example, the color fringing map may include information on position information and/or a color fringing degree of pixels with which color fringing occurs.

According to an embodiment, the electronic device 100 may process a region including pixels with which color fringing occurs differently from the remaining region based on the color fringing map and then, obtain the output image (e.g., pentile sub pixel structure image) by muxing (940) the processed image.

According to an example, the electronic device 100 may apply the sub-pixel rendering and/or a color difference compensation as shown in FIG. 5A and FIG. 5B for only the region including pixels with which color fringing occurs. According to an example, the electronic device 100 may determine the weight values for sub-pixel rendering differently with respect to a region that includes pixels with which color fringing occurs based on information included in the color fringing map. The electronic device 100 may perform only the operation for transforming the remaining region to the pentile structure. This is because there is no need to generate a blurring phenomenon through sub-pixel rendering for a region in which color fringing does not occur. Accordingly, blurring of clarity may be prevented by not performing unnecessary processing in the region in which color fringing does not occur,

As described above, in an example case in which the sub-pixel rendering and/or the color difference compensation is applied to only the region including pixels with which color fringing occurs, the blurring phenomenon caused by sampling (e.g., pentile sampling) may be more effectively prevented.

According to the various embodiments described above, to reduce color fringing which occurs in the display of the pentile structure, blurring of clarity may be prevented while improving a color fringing reduction performance by predicting how much color fringing color fringing occurs from a cognitive perspective and compensating by performing diffusion to surrounding pixels. In addition, blurring of clarity may be prevented by not performing unnecessary processing in a region in which color fringing does not occur.

The methods according to the various embodiments of the disclosure described above may be implemented in an application form installable in an electronic device of the related art. However, the disclosure is not limited thereto, and as such, methods according to the various embodiments of the disclosure described above may be performed using a deep learning-based artificial neural network (or deep artificial neural network), that is, a learning network model.

The methods according to the various embodiments of the disclosure described above may be implemented with only a software upgrade, or a hardware upgrade for the electronic device of the related art.

The various embodiments of the disclosure described above may be performed through an embedded server provided in the electronic device, or through an external server of the electronic device.

According to an embodiment of the disclosure, the various embodiments described above may be implemented with software including instructions stored in a machine-readable storage media (e.g., computer). The machine may call a stored instruction from a storage medium, and as a device operable according to the called instruction, may include the electronic device (e.g., electronic device (A)) according to the above-mentioned embodiments. Based on a command being executed by the processor, the processor may directly or using other elements under the control of the processor perform a function corresponding to the command. The command may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment of the disclosure, a method according to the various embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the machine-readable storage medium such as a server of a manufacturer, a server of an application store, or a memory of a relay server, or temporarily generated.

In addition, each of the elements (e.g., a module or a program) according to the various embodiments described above may be configured as a single entity or a plurality of entities, and a portion of sub-elements of the above-mentioned sub-elements may be omitted, or other sub-elements may be further included in the various embodiments. Alternatively or additionally, a portion of the elements (e.g., modules or programs) may be integrated into one entity to perform the same or similar functions performed by the respective relevant elements prior to integration. Operations performed by a module, a program, or another element, in accordance with various embodiments, may be executed sequentially, in a parallel, repetitively, or in a heuristic manner, or at least a portion of the operations may be executed in a different order, omitted or a different operation may be added.

While the disclosure has been illustrated and described with reference to various example embodiments thereof, it will be understood that the various example embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic device, comprising;
a display comprising first pixels, each of the first pixels comprising a first number of first sub pixels; and
a system on Chip (SoC),
wherein the SoC is configured to:
receive an input image comprising second pixels, each of the second pixels comprising a second number of second sub pixels,
obtain, based on the second number of the second sub pixels being greater than the first number of the first sub pixels a sampling image by sampling the input image based on the first sub pixels,
obtain a first filtering image by applying a first human visual system (HVS) filtering to the sampling image,
obtain a second filtering image by applying a second HVS filtering to the input image,
obtain an output image by compensating a color value of the sampling image based on a color difference of the first filtering image and the second filtering image, and
display the output image on the display.

2. The electronic device of claim 1, wherein
the SoC is further configured to:
compensate the sampling image by compensating for the color difference of the second filtering image and the first filtering image corresponding to a first pixel in the first filtering image by performing diffusion to the first pixel and a plurality of surrounding pixels surrounding the first pixel.

3. The electronic device of claim 2, wherein
the SoC is further configured to:
compensate for a first color difference of the first filtering image and the second filtering image corresponding to a first sub pixel in the first pixel by performing diffusion to the first sub pixel and a plurality of first adjacent sub pixels surrounding the first sub pixel, and
compensate for a second color difference of the first filtering image and the second filtering image corresponding to a second sub pixel in the pixel by performing diffusion to the second sub pixel and a plurality of second adjacent sub pixels surrounding the second sub pixel.

4. The electronic device of claim 3, wherein
the SoC is further configured to:
compensate for the first color difference corresponding to the first sub pixel by performing diffusion to the first sub pixel and the plurality of first adjacent sub pixels based on a first weight value corresponding to the first sub pixel and a second weight value corresponding to the plurality of first adjacent sub pixels, and
compensate for the second color difference corresponding to the second sub pixel by performing diffusion to the second sub pixel and the plurality of second adjacent sub pixels based on a third weight value corresponding to the second sub pixel and a fourth weight value corresponding to the plurality of second adjacent sub pixels.

5. The electronic device of claim 4, wherein
the SoC is further configured to:
identify the first weight value and the second weight value based on pre-set weight values or at least one from among a filter coefficient applied to the first HVS filtering, positions of the first sub pixel and the plurality of first adjacent sub pixels, and the first color difference, and
identify the third weight value and the fourth weight value based on the pre-set weight values or at least one from among a filter coefficient applied to the second HVS filtering, positions of the second sub pixel and the plurality of second adjacent sub pixels, and the second color difference.

6. The electronic device of claim 1, wherein
the SoC is further configured to:
identify a first luminance value corresponding to a first pixel of the first filtering image and a second luminance value corresponding to a second pixel of the second filtering image, the second pixel of the second filtering image corresponding to the first pixel of the first filtering image,
identify a color difference of the first filtering image and the second filtering image based on a first color value and the first luminance value of the first pixel of the first filtering image, and a second color value and the second luminance value of the second pixel of the second filtering image, and
compensate the sampling image by compensating for the color difference by performing diffusion to the first pixel and the a plurality of pixels surrounding the first pixel.

7. The electronic device of claim 6, wherein
the SoC is further configured to:
identify a color difference of the first filtering image and the second filtering image based on a first difference value having subtracted the first luminance value from the first color value for each sub pixel in the first pixel of the first filtering image and a second difference value having subtracted the second luminance value from the second color value for each sub pixel in the second pixel of the second filtering image.

8. The electronic device of claim 1, wherein
the SoC is further configured to:
obtain one red (R) sub pixel value in the sampling image based on a plurality of R sub pixel values in the input image, obtain one green (G) sub pixel value in the sampling image based on a plurality of G sub pixel values in the input image, and obtain one blue (B) sub pixel value in the sampling image based on a plurality of B sub pixel values in the input image.

9. The electronic device of claim 1, wherein
the SoC is further configured to:
predict a first region in which color fringing occurs in the input image based on pixel information of the input image, and
obtain the output image based on the sampling image in which the color value is compensated for the first region and based on the sampling image in which the color value is not compensated for a second region in the input image.

10. The electronic device of claim 1, wherein
the display is implemented as a pentile display of an RGBG sub pixel structure in which each pixel comprises an R sub pixel and a G sub pixel, or comprises a B sub pixel and the G sub pixel.

11. A control method of an electronic device including a display including first pixels, each of the first pixels including a first number of first sub pixels, the method comprising:
receiving an input image including second pixels, each of the second pixels including a second number of second sub pixels,
obtaining, based on the second number of the second sub pixels being greater than the first number of the first sub pixels, a sampling image by sampling the input image based on the first sub pixels;
obtaining a first filtering image by applying a first human visual system (HVS) filtering to the sampling image;
obtaining a second filtering image by applying a second HVS filtering to the input image;
obtaining an output image by compensating a color value of the sampling image based on a color difference of the first filtering image and the second filtering image; and
displaying the output image on the display.

12. The method of claim 11, wherein
the obtaining the output image comprises:
compensating the sampling image by compensating for the color difference of the second filtering image and the first filtering image corresponding to a first pixel in the first filtering image by performing diffusion to the first pixel and a plurality of surrounding pixels surrounding the first pixel.

13. The method of claim 12, wherein
the compensating the sampling image comprises:
compensating for a first color difference of the first filtering image and the second filtering image corresponding to a first sub pixel in the first pixel by performing diffusion to the first sub pixel and a plurality of first adjacent sub pixels surrounding the first sub pixel, and
compensating for a second color difference of the first filtering image and the second filtering image corresponding to a second sub pixel in the pixel by performing diffusion to the second sub pixel and a plurality of second adjacent sub pixels surrounding the second sub pixel.

14. The method of claim 13, wherein
the compensating the sampling image comprises:
compensating for the first color difference corresponding to the first sub pixel by performing diffusion to the first sub pixel and the plurality of first adjacent sub pixels based on a first weight value corresponding to the first sub pixel and a second weight value corresponding to the plurality of first adjacent sub pixels; and
compensating for the second color difference corresponding to the second sub pixel by performing diffusion to the second sub pixel and the plurality of second adjacent sub pixels based on a third weight value corresponding to the second sub pixel and a fourth weight value corresponding to the plurality of second adjacent sub pixels.

15. The method of claim 14, wherein
the compensating the sampling image comprises:
identifying the first weight value and the second weight value based on pre-set weight values or at least one from among a filter coefficient applied to the first HVS filtering, positions of the first sub pixel and the plurality of first adjacent sub pixels, and the first color difference, and
identifying the third weight value and the fourth weight value based on the pre-set weight values or at least one from among a filter coefficient applied to the second HVS filtering, positions of the second sub pixel and the plurality of second adjacent sub pixels, and the second color difference.

16. The method of claim 14, wherein
the obtaining the output image comprises:
identifying a first luminance value corresponding to a first pixel of the first filtering image and a second luminance value corresponding to a second pixel of the second filtering image, the second pixel of the second filtering image corresponding to the first pixel of the first filtering image,
identifying a color difference of the first filtering image and the second filtering image based on a first color value and the first luminance value of the first pixel of the first filtering image, and a second color value and the second luminance value of the second pixel of the second filtering image, and
compensating the sampling image by compensating for the color difference by performing diffusion to the first pixel and the a plurality of pixels surrounding the first pixel.

17. The method of claim 16, wherein
the identifying the color difference of the first filtering image and the second filtering image comprises:
identifying a color difference of the first filtering image and the second filtering image based on a first difference value having subtracted the first luminance value from the first color value for each sub pixel in the first pixel of the first filtering image and a second difference value having subtracted the second luminance value from the second color value for each sub pixel in the second pixel of the second filtering image.

18. The method of claim 11, wherein
the obtaining the sampling image comprises:
obtaining one red (R) sub pixel value in the sampling image based on a plurality of R sub pixel values in the input image, obtain one green (G) sub pixel value in the sampling image based on a plurality of G sub pixel values in the input image, and obtain one blue (B) sub pixel value in the sampling image based on a plurality of B sub pixel values in the input image.

19. The method of claim 11, further comprises:
predicting a first region in which color fringing occurs in the input image based on pixel information of the input image, and
obtaining the output image based on the sampling image in which the color value is compensated for the first region and based on the sampling image in which the color value is not compensated for a second region in the input image.

20. A non-transitory computer-readable medium that stores instructions for an electronic device to perform an operation when executed by a System on Chip (SoC) of the electronic device that includes a display including first pixels, each of the first pixels including a first number of first sub pixels, wherein the operation comprises:
receiving an input image including second pixels, each of the second pixels including a second number of second sub pixels,
obtaining, based on the second number of the second sub pixels being greater than the first number of the first sub pixels, a sampling image by sampling the input image based on the first sub pixels;
obtaining a first filtering image by applying a first human visual system (HVS) filtering to the sampling image;
obtaining a second filtering image by applying a second HVS filtering to the input image;
obtaining an output image by compensating a color value of the sampling image based on a color difference of the first filtering image and the second filtering image; and
displaying the output image on the display.
